(19) United States
(12) Patent Application Publication
(10) Pub. No.: US 2003/0095167 A1
(43) Pub. Date: May 22, 2003

(54) Apparatus and method to produce topography, unique fluid handling properties and bonding properties on and within substrates

(76) Inventors: Lee Kirby Jameson, Roswell, GA (US); Teresa De Jesus Petryk, Woodstock, GA (US); Varunesh Sharma, Atlanta, GA (US); Phillip A. Schorr, Atlanta, GA (US)

Correspondence Address: William W. Letson, Kimberly-Clark Worldwide, Inc., Patent Department, 401 North Lake Street, Neenah, WI, 54956, US

(21) Appl. No.: 09/991,185

(22) Filed: Nov. 16, 2001

(51) Int. Cl. B41J 2/175; H04L 12/66

(52) U.S. Cl. 347/85; 347/88

(57) ABSTRACT

The present invention relates to an apparatus for the discrete and registered placement of chemistry. The apparatus having (i) at least one solenoid valve, the valve including an orifice; (ii) at least one chemistry source, the at least one chemistry source being in communication with the at least one valve, and being capable of communicating at least one chemistry to at least one solenoid valve; and (iii) a heating element; wherein the heating element is positioned proximate to at least one chemistry, and wherein the heating element allows the apparatus to process phase-change materials. A second embodiment of the present invention is directed to an ink-jet printing device for the registered placement of phase-change liquids. The present invention is also directed to a method for placing one or more chemistries in a discrete and registered fashion.

### BACKGROUND OF THE INVENTION

Drop on demand valved ink jet printing apparatus have been used to apply inks to a variety of substrates for a period of time. Generally, a drop on demand valved ink jet printing apparatus operates to discharge individual droplets of ink onto a substrate in a predetermined pattern to be printed. Such an apparatus typically incorporates an array of orifices in a nozzle block, a plurality of control valves, and a controller. The orifices are customarily arranged in a vertical row, and conventional ink jet printing apparatus have incorporated a separate valve communicating with each orifice. The valves are controlled by the controller, which can be keyed by an operator to open and close the nozzles according to a programmed schedule to print one or a series of characters or symbols.

Each orifice is designed to emit a single droplet of ink during each opening of its associated valve. The droplets, emitted according to the programmed sequence, are directed toward a substrate where the character or symbol is printed. The quality of print produced by a drop on demand ink jet printer requires among other things, precise control over the size of the ink dot that impacts the substrate. Dot size in turn is affected by the size of an ink droplet discharged from a nozzle.

In the past, it was important in the overall design represented by the relationship between valve characteristics, orifice size, and ink characteristics, that the droplets not only be of proper size but also that the size be consistent because otherwise the printed characters or symbols would be irregular in width.

Typically, in early ink jet printing apparatus, a nozzle orifice array consisted of a vertical row of seven orifices coupled with seven control valves. Each control valve controlled the flow of ink through its associated orifice. An example of such a drop on demand ink jet printing apparatus is described and illustrated in U.S. Pat. No. 4,378,564. The subject matter disclosed by that patent is incorporated herein by reference.

In time, the need developed for an increased number of orifices. To meet this need, a larger number of orifices were assembled in a taller vertical array, and a correspondingly greater number of valves were incorporated, again, each nozzle orifice having its own control valve. The typical approach was to increase the number of orifices by superimposing two or more orifice nozzle arrays, each array incorporating the same number of valves as orifices. Of course, with each increase in the number of valves, the cost of the printing apparatus also increased.

DE-A1-3 337 495 shows a drop on demand ink jet printing system having a nozzle support, a plurality of nozzles, each nozzle having an orifice, a control valve having a chamber, an inlet valve communicating with the chamber and with a source of ink, and a plurality of outlet parts communicating with the chamber, and with a plurality of nozzle orifices, and a rotatably movable closure means disposed in the chamber and having a position which by virtue of parting thereon facilitates opening and closing communication simultaneously between all the outlet parts.

A factor in the operation of the conventional equipment, and specifically the device of DE-A1-3 337 495, is surface tension of the ink. There is a tube connecting each valve outlet port with its associated orifice. When the valve closes, but for surface tension at the orifice opening, ink in the tube would continue to flow through the orifice and destroy the droplet. This surface tension, resulting from viscosity of the ink and the diameter of the orifice, resists the ink pressure upstream of the orifice.

This surface tension at the orifice opening holds ink within the tubing between a valve and an orifice after the valve closes. Without the surface tension, upon closing of the valve upstream of the tubing, ink would drain from the tubing through the orifice. Such surface tension would be lost, for example, if the tubing upstream of the orifice was exposed to the atmosphere and if the strength of the surface tension could not counteract atmospheric pressure. Also, head pressure differentials do not exist at the orifices if the tubes are not exposed to atmospheric pressure. Because of the surface tension, the flow of ink stops immediately when the valve closes. When the valve opens again, a droplet instantly begins to form and, because of the ink source pressure, the droplet is completed and discharged from the orifice in the short time the valve is open.

As has been said, in order for the valve to maintain its precision of operation over many millions of cycles of opening and closing, the design of the valve is crucial. In the conventional ink jet printing system, each valve is solenoid operated and has an ink chamber with a single inlet port and a single outlet port communicating with the chamber. A piston face is actuable against a valve seat surrounding the outlet port to open and close the valve. In that valve, the chamber is large enough to accommodate a piston head having a smaller stem of magnetically responsive metal so that the stem can function as the core of a solenoid. A compression spring normally holds a face of the piston head in contact with the outlet port seat to close the valve. When the valve is closed, the inlet port remains in communication with the chamber. When the solenoid is energized, its magnetic field overcomes the strength of the compression spring and withdraws the piston head from the outlet port, allowing ink to flow from the inlet port, through the chamber to the outlet port. When the magnetic field is released, the compression spring drives the piston head back to close the outlet port.

In much of the ink jet printing done heretofore, the spacing between orifices has produced a printed character or symbol composed of essentially discrete dots of ink. Because of the number of them, these discrete dots have been acceptable in producing a readable character or symbol. However, the traditional ink jet printing apparatus was not acceptable to print bar codes because of the specifications for bar code printing required to assure accurate reading of the bar codes. Heretofore, nor have traditional ink jet printing apparatus been acceptable for the printing of non-ink chemistries where continuity of chemistry application, at least in certain regions, may be important.

To eliminate the waves on the side edges of a printed line or “smooth out” the composite side edges of a resulting printed bar, the printed dots must overlap one another. The conventional way to accomplish this would be to produce a nozzle assembly having a large number of orifices in a vertical row positioned very close to one another so their images, after wicking, would overlap one another, and to provide a correspondingly large number of control valves. In conventional apparatus, each orifice would be under the control of an undivided valve connected to it. This addition of valves would add to the cost of the ink jet printing apparatus and to the volume occupied by or space required to operate them.

To overcome some of the difficulties associated with conventional ink-jet printing apparatus, a number of other improvements were made. For example, in EP 0297753 B1, a valve printer is described. In the valve of that invention, there is an ink chamber. A single inlet port to the chamber communicates with a source of ink under predetermined pressure. There are a plurality of outlets ports also communicating with the chamber. A piston is operable within the chamber to alternately simultaneously block and simultaneously unblock all outlet ports. Each outlet port is connected by tubing to an individual orifice, but since there are a plurality of outlet ports, a single valve controls the flow of ink through a corresponding plurality of orifices. Surface tension can be maintained at each orifice opening so that at the instant the piston closes the outlet ports, the flow of ink stops and, upon withdrawal of the piston from the outlet ports, ink instantly flows to all of the orifices where ink droplets are formed and discharged. The EP 0297753 B1 invention also includes a nozzle block having an array of orifices that are close enough together to smooth out the side edges of a printed vertical line or bar. The distance between orifice centers is substantially one half the diameter of the dot as printed. To produce the overlapping printed dots requires an increased number of orifices, 64 in the preferred embodiment.

While many improvements to conventional ink jet printing apparatus have been made, the ink jet printing apparatus currently available lack the ability to process phase-change liquids or materials and/or the ability to provide enhanced fluid handling characteristics (e.g. topography or fluid barrier) in a single pass of the apparatus across the substrate (or a single pass of the substrate past the apparatus). Additionally, due to the separation of discrete segments upon application to the substrate, conventional ink jet printing apparatus are not acceptable for the printing of non-ink chemistries where continuity of chemistry application, at least in certain regions, may be important.

### SUMMARY OF THE INVENTION

The present invention relates to an apparatus for the discrete and registered placement of chemistry. The apparatus having (i) at least one solenoid valve, the valve including an orifice; (ii) at least one chemistry source, the at least one chemistry source being in communication with the at least one valve, and being capable of communicating at least one chemistry to at least one solenoid valve; and (iii) a heating element; wherein the heating element is positioned proximate to at least one chemistry, and wherein the heating element allows the apparatus to process phase-change materials. The apparatus of the present invention may also provide for the at least one solenoid valve to be controlled in such a manner so as to discharge the at least one chemistries in a pattern. The apparatus is capable of discharging discrete segments of chemistry, which may be applied to a substrate so as to create a topography of chemistry, wherein the topography may provide skin health benefits. The application of topography to a substrate can provide a substrate which exhibits improved fluid management and/or skin separation during use.

In a second aspect of the invention, a printing device for the registered placement of phase-change liquids is provided. The device includes (i) at least one solenoid valve, said valve having a discharge orifice; (ii) a heating element, the heating element being capable of providing heat to the device so as to allow the device to utilize or process phase-change liquids; (iii) a chemistry supply, the supply being in fluid communication with at least one solenoid valve; and (iv) a control means, in communication with the at least one solenoid valve. In one aspect of the present invention it is desirable that the at least one valve of the device project droplets or discrete segments of chemistry from the orifice, wherein the chemistry contains, at least in part, one or more phase-change liquids.

The present invention is also directed to a process for placing one or more chemistries in a discrete and registered fashion. The method includes (i) providing a valve jet, the jet comprising: at least one solenoid valve, the valve containing an orifice; at least one chemistry source, said at least one chemistry source being in communication with said at least one valve, and being capable of communicating at least one chemistry to at least one solenoid valve; and a heating element; wherein the heating element is positioned proximate to at least one chemistry, and wherein the heating element allows the apparatus to process phase-change materials; (ii) providing an amount of chemistry; (iii) communicating the chemistry from at least one chemistry source to at least one solenoid valve; (iv) providing heat to at least one chemistry; and (iv) discharging at least one chemistry from at least one solenoid valve. The method of the present invention may further include the step of providing a substrate, wherein the discharged chemistry forms discrete segments on the substrate. The step of discharging the chemistry from the at least one solenoid valve may include firing or pulsing one or more of the at least one valves. In one embodiment of the invention the valve jet may also include a control element or control means, wherein the control element is in communication with the at least one solenoid valves. The control element will permit the at least one solenoid valve to be regulated in such a manner either together or independently, so as to permit the chemistry which is discharged therefrom onto the substrate to be deposited so as to create or generate a pattern. The generated pattern or patterns desirably, but need not include, overlapping or partially overlapping segments, and the pattern may be one which is repeating, non-repeating or random. Further aspects of the method of the present invention allow for the application of the desired chemistry or chemistries in one pass of the substrate past the valve jet. The application of the desired chemistries may be done so as to create a topography of chemistry, wherein the topography may provide skin health benefits. Another aspect of the method of the present invention is that the discrete segments may be applied to the substrate so as to create bond points, wherein the bond points may be either inter-fiber bond points or interfacial bond points.

### BRIEF DESCRIPTION OF THE DRAWINGS

FIG. 1 is a perspective view illustration of one embodiment of an ink jet printing apparatus of the present invention. The apparatus is shown with the chemistry source cover removed.

FIG. 2 is a perspective illustration of the apparatus of FIG. 1, wherein the cover is in place.

FIG. 3 is an enlarged perspective view of the apparatus shown in FIGS. 1 and 2.

### DEFINITIONS

As used herein the following terms have the specified meanings, unless the context demands a different meaning, or a different meaning is expressed; also, the singular generally includes the plural, and the plural generally includes the singular unless otherwise indicated.

As used herein, the terms “comprises”, “comprising” and other derivatives from the root term “comprise” are intended to be open-ended terms that specify the presence of any stated features, elements, integers, steps, or components, but do not preclude the presence or addition of one or more other features, elements, integers, steps, components, or groups thereof.

As used herein, the term “fabric” refers to all of the woven, knitted and nonwoven fibrous webs.

As used herein, the term “layer” when used in the singular can have the dual meaning of a single element or a plurality of elements.

As used herein, the terms “lotion” or “ointment” are generally interchangeable and mean a formulation, powder or combination thereof comprising skin health ingredients, or compositions which are skin compatible but which do not in and of themselves provide skin health or skin wellness benefits.

As used herein the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin et al. Meltblown fibers are microfibers which may be continuous or discontinuous, are generally smaller than 10 microns in average diameter, and are generally tacky when deposited onto a collecting surface.

As used herein “multi-layer laminate” means a laminate wherein some of the layers are spunbond and some meltblown such as a spunbond/meltblown/spunbond (SMS) laminate and others as disclosed in U.S. Pat. No. 4,041,203 to Brock et al., U.S. Pat. No. 5,169,706 to Collier, et al, U.S. Pat. No. 5,145,727 to Potts et al., U.S. Pat. No. 5,178,931 to Perkins et al. and U.S. Pat. No. 5,188,885 to Timmons et al. Such a laminate may be made by sequentially depositing onto a moving forming belt first a spunbond fabric layer, then a meltblown fabric layer and last another spunbond layer and then bonding the laminate in a manner described below. Alternatively, the fabric layers may be made individually, collected in rolls, and combined in a separate bonding step. Such fabrics usually have a basis weight of from about 0.1 to 12 osy (6 to 400 gsm), or more particularly from about 0.75 to about 3 osy. Multi-layer laminates may also have various numbers of meltblown layers or multiple spunbond layers in many different configurations and may include other materials like films (F) or coform materials, e.g. SMMS, SM, SFS, etc.

As used herein the terms “nonwoven” and “nonwoven fabric or web” mean a web having a structure of individual fibers, filaments or threads which are interlaid, but not in an identifiable manner as in a knitted fabric. Nonwoven fabrics or webs have been formed from many processes such as for example, meltblowing processes, spunbonding processes, and bonded carded web processes. The basis weight of nonwoven fabrics is usually expressed in ounces of material per square yard (osy) or grams per square meter (gsm) and the fiber diameters useful are usually expressed in microns. (Note that to convert from osy to gsm, multiply osy by 33.91).

As used herein, the term “personal care product” or “personal care absorbent product” means diapers, training pants, swim wear, absorbent underpants, baby wipes, adult incontinence products, sanitary wipes, wet wipes, feminine hygiene products, wound dressings, nursing pads, time release patches, bandages, mortuary products, veterinary products, hygiene and absorbent products.

As used herein, the term “petrolatum” refers to a semisolid mixture of hydrocarbons obtained from petroleum, such as, but not limited to Glenpure L White Petrolatum, USP available from Glenn Corporation, a business having offices in St. Paul, Minn.

As used herein, the term “phase-change” application, chemistry, liquid, material or the like refers to a material which is processed in a liquid or substantially liquid state and then solidifies when cooled.

As used herein the term “spunbonded fibers” refers to small diameter fibers which are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, and U.S. Pat. No. 3,542,615 to Dobo et al. Spunbond fibers are generally not tacky when they are deposited onto a collecting surface. Spunbond fibers are generally continuous and have average diameters (from a sample of at least 10) larger than 7 microns, more particularly, between about 10 and 20 microns.

As used herein, the term “topical application” means any overlayer type of material surface modification, including, but not limited to any polishes, cleaning or cleansing agents, and the like, as well as any lotions, ointments, powders or the like and combinations thereof. For purposes of this application, the term “surface enhancing agent” is generally interchangeable with the term topical application.

These terms may be defined with additional language in the remaining portions of the specification.

### DETAILED DESCRIPTION OF THE INVENTION

### Description of the Invention

One aspect of the present invention relates to an apparatus for the discrete and registered placement of chemistry. The apparatus having (i) at least one solenoid valve, the valve including an orifice; (ii) at least one chemistry source, in communication with the at least one valve, and capable of communicating at least one chemistry to at least one solenoid valve; and (iii) a heating element; wherein the heating element is positioned proximate to at least one chemistry, and wherein the heating element allows the apparatus to process phase-change materials. In a further aspect, the apparatus may further include a controller or a control means, wherein the control means is in communication with the at least one solenoid valve. The control means is desirably capable of operating in multiple modes and may control the valves such that they act together or independently from one another. One skilled in the art will appreciate that any number of control means are suitable for use with the present invention. Exemplary control means may vary from manual to computer controlled or computer regulated control elements (e.g. manual switches, line driven switches, photo-optic sensors, and software driven switching circuits).

In a further aspect of the present invention, the apparatus may also include a pressure source, wherein the pressure source maintains adequate pressure in the apparatus so as to assist in the regulation or control of the chemistry discharge from the at least one orifice. In one embodiment, the pressure source may be part of the at least one chemistry source or, alternatively, it may comprise a separate pressure regulating means or system which may be connected to the apparatus in a variety of ways. It is contemplated that the pressure source may be capable of increasing and/or decreasing pressure. The pressure may be controlled in a variety of manners including commercially known methods of increasing pressure (e.g. air pumps, etc.) and/or decreasing pressure (e.g. pressure relief or “bleeding off” valves or the use of a vacuum means). In addition to helping or assisting in the regulation of pressure throughout one or more components of the apparatus of the present invention, the pressure source may also contribute, directly or indirectly, to the communication of the at least one chemistry or application to the at least one valve of the present invention.

In yet another aspect of the present invention, the apparatus may include a temperature sensor, wherein the temperature sensor measures, and optionally allows for the control of, the temperature of the at least one chemistry in or which pass through the apparatus. One skilled in the art will appreciate that more than one sensor may be used where multiple chemistries are used with the apparatus.

The apparatus of the present invention may also provide for the at least one solenoid valve to be controlled in such a manner so as to discharge the at least one chemistries in a pattern. In yet a further aspect of the present invention, the apparatus may also include a manifold plate, with the at least one valve positioned in the manifold plate. In those embodiments of the present invention which include a manifold plate, any number of potential arrangements of the valves is contemplated. For example, the valves may be oriented in a side by side orientation relative to the x or y axes of the apparatus, or the valves may be positioned in a staggered fashion where multiple rows of valves are present. While the number and proximity of the valves are obviously limited within a manifold plate by the diameters of the valves, in that the valves, and correspondingly the valve's respective orifices, can be no closer to one another than their diameters permit, the size of the valves may be varied to reduce any coverage gaps which may otherwise be present. Alternatively, as mentioned above, the valves may be oriented in a staggered fashion. Although physical limitations are one consideration, another factor which should be considered in the design of a multi-valve system includes but is not limited to, the quality of the materials used to construct the printing apparatus. That is, depending on the quality (e.g. shock-absorbing ability, insulative properties, thickness, etc.) of materials used the spacing of the valves may be further limited. For example, if not properly adjusted the vibration of proximately positioned valves could cause unintended or undesired seepage of a chemistry. Also if the electronics used to control the valves are not adequately insulated or spaced, electrical cross-over may occur which could result in the unintended firing or pulsing of one or more valves. Again, while these are concerns or considerations when designing an apparatus of the present invention, the only limitation which cannot be overcome is that the valves can be no closer than their diameters allow.

In one embodiment of the invention, at least one chemistry source may be selected from a direct source such as a reservoir, tank or the like, or the chemistry source may be a continuous feed system or the like. In either instance the source desirably includes a channel, tubing or the like which provides for the communication of the at least one chemistry to the at least one valve. The desired embodiment will include a manifold plate. Where a manifold plate is included in the apparatus of the present invention, the chemistry is desirably communicated through the manifold to at least one solenoid valve without the need for additional tubing to communicate the ink to the valve and then to the orifice as with conventional ink jet printing apparatus. In those embodiments including a manifold plate where the use of multiple chemistries is contemplated, the manifold plates will desirably have at least one channel, groove, or the like therein for each of the chemistries.

In yet still another aspect of the present invention, the apparatus discharges discrete segments of chemistry. Although discrete segments of many sizes are contemplated, the apparatus desirably discharges discrete droplets or segments which have a volume of between about 5 nanoliters and about 400 nanoliters and/or a length and width less than about 5 mm, and more desirably less than about 3 mm, and still more desirably less than about 2 mm and greater than about 0.2 mm. Desirably, the discrete segments are discharged at a frequency between about 1 Hz and about 2 kHz. Furthermore, as discussed in more detail here in, the apparatus may process chemistries having a vast range of the viscosities, it is desirable that the viscosity of the others have chemistry discharged from the valve just is between about 1 and about 300 centipoise and more desirably between about 10 and about 100 centipoise at the time of discharge. In a final aspect of one embodiment of the invention, the apparatus can apply the chemistry to a substrate so as to create a topography of chemistry, wherein the topography desirably may provides or produces skin health benefits. The application of topography to a substrate can provide a final product or component thereof which exhibits improved fluid management and/or skin separation during use.

In a further aspect of the invention, a printing device for the registered placement of phase-change liquids is provided. The printing device includes (i) at least one solenoid valve, said valve having a discharge orifice; (ii) a heating element, the heating element being capable of providing heat to the device so as to allow the device to utilize or process phase-change liquids; (iii) a chemistry supply, the supply being in fluid communication with at least one solenoid valve; and (iv) a control means, in communication with the at least one solenoid valve. The chemistry supply may, for example, be a reservoir or a feed system. In one aspect of the present invention it is desirable that the at least one valve of the device project droplets of chemistry from the orifice, wherein the chemistry contains, at least in part, one or more phase-change liquids. The chemistry or chemistries contemplated by the present invention include those which are intended for use topically, internally or both. Although the desired embodiments of the present invention are directed to use with or in personal care products or the like, where the use of skin unfriendly components generally needs to be limited or avoided, in those instances where the chemistry is used to print on something other than items which will contact or be used intimately with the skin, any suitable components may be used. Thus, the only limitation on chemistries which may be used in connection with the present invention is that the chemistries must be capable of being processed by the apparatus of the present invention.

The present invention is also directed to a method for placing one or more chemistries in a discrete and registered fashion. The method includes (i) providing a valve jet, said jet comprising: at least one solenoid valve, said valve containing an orifice; at least one chemistry source, in communication with said at least one valve, and being capable of communicating at least one chemistry to at least one solenoid valve; and a heating element; wherein the heating element is positioned proximate to at least one chemistry, and wherein the heating element allows the apparatus to process phase-change materials; (ii) providing an amount of chemistry; (iii) communicating the chemistry from at least one chemistry source to at least one solenoid valve; (iv) providing heat to at least one chemistry; and (iv) discharging at least one chemistry from at least one solenoid valve. Although, in some embodiments, it will be desirable for the heating element to be placed along the apparatus of the present invention so that the heating element comes in direct contact with the chemistry, the heating element need not do so. That is, the heating element may be placed on or within the apparatus such that at least some of the heat generated by the element is conveyed to at least one chemistry. More specifically, one or more heating elements or components thereof may be positioned on or in the apparatus such that the heat emitted therefrom is passed to at least one chemistry by heat transfer. Alternatively, the heating elements and the amount of heat generated thereby may be selected depending on the materials used to construct the apparatus of the present invention and the chemistries expected to be used therewith such that the heating element or elements generate enough heat which may subsequently be passed through the materials of the apparatus to at least one of the chemistries, so as to allow the processing threat.

The method of the present invention may further include the step of providing a substrate, wherein the discharged chemistry forms discrete droplets or segments on the substrate. The method of the present invention, contemplates the use of any suitable substrate. The suitability of a particular substrate may depend, at least in part, on the chemistries being used in conjunction therewith. Exemplary substrates include, but are not limited to, wovens, nonwovens, paper, films, tissue, metals and generally any surface of any product which is capable of having the chemistry or chemistries described herein applied thereto either in the manner described or so as to produce the materials discussed herein. The step of discharging the chemistry from the at least one solenoid valve may include firing one or more of the at least one valves. In one embodiment of the invention the valve jet may also include a control element or control means, wherein the control element is in communication with one or more of the at least one solenoid valves. The control element will permit the at least one solenoid valve to be regulated in such a manner so as to permit the chemistry which is discharged therefrom onto the substrate to be deposited so as to create or generate a pattern. The generated pattern or patterns desirably, but need not include, overlapping or partially overlapping segments, and the pattern may be one which is repeating, non-repeating or random.

In another aspect of the present invention, the control element may also provide for real-time adjustment of the discharge from the at least one solenoid valve. Real-time adjustment allows or provides for the immediate or essentially instantaneous control or change in the operation of the printing apparatus of the present invention. The speed at which the apparatus of the present invention may be adjusted is limited only by the time equal to one-half of the minimum period of pulse period associated with the valves of the apparatus. That is, the minimum pulse or firing period is the shortest time it takes for the valve in question to change from a closed position to an open or firing position and return to a closed position (or to change from an open position to a closed position and back to an open position). A portion of the period at a given frequency would be the amount of time necessary for a valve of the apparatus to change from an open position to a closed position or from a closed position to an open position, and thus the minimum time needed for the apparatus or one or more of its valves to change its operation (i.e. print if not printing or stop printing if printing). As the operation speed of valves suitable for use in the present invention continues to increase, so too will the firing frequency resulting in decreased pulse period; however, currently the minimum pulse frequency associated with one embodiment of an apparatus of the present invention is about 1.2 kHz or 1/1,200^{th} of a second.

Real-time control may also be combined with one or more sensors located along the machines being used to produce the final component or product such that changes in the pattern, amount, position, etc. of the chemistry can be made. Real-time changes in the operation of the apparatus of the present invention may be beneficial if multiple sizes or shapes of materials are being processed by the printing apparatus such that different patterns, applications or orientations thereof or the like are desired depending on the product or component being processed.

Further aspects of the method of the present invention allow for the application of the desired chemistry or chemistries in one pass of the substrate past the valve jet. The application of the desired chemistries may be done so as to create a topography of chemistry, wherein the topography may provide skin health benefits. The method of the present invention may also provide for the discrete segments to have a substantially semicircular cross-section extending above the substrate. The at least one chemistry is contemplated to include any chemistry, application or composition or the like which is suitable for processing or printing by the apparatus of the present invention, and may include, but is not limited to, medicaments, inks, waxes, paints, lotions, ointments, skin health agents, topical applications, and the like or combinations thereof. In at least one embodiment at least one of the at least one chemistries will desirably be or will desirably comprise in part a phase-change material.

Another aspect of the method of the present invention is that the discrete segments may be applied to the substrate so as to create bond points, wherein the bond points may be either inter-fiber bond points or interfacial bond points. One of skill in the art will recognize that some of the application methods described in more detail below will work better than others within the ranges specified herein and that the chemistries should be selected accordingly.

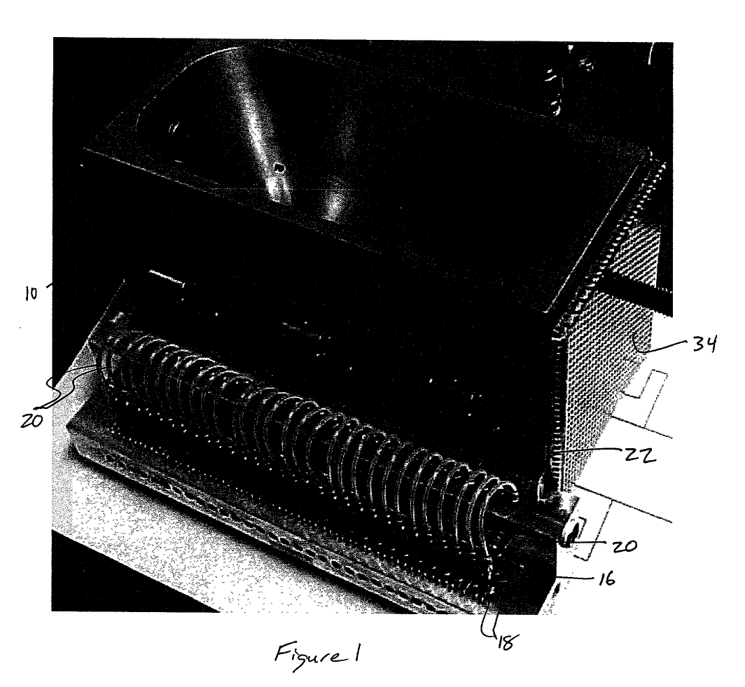

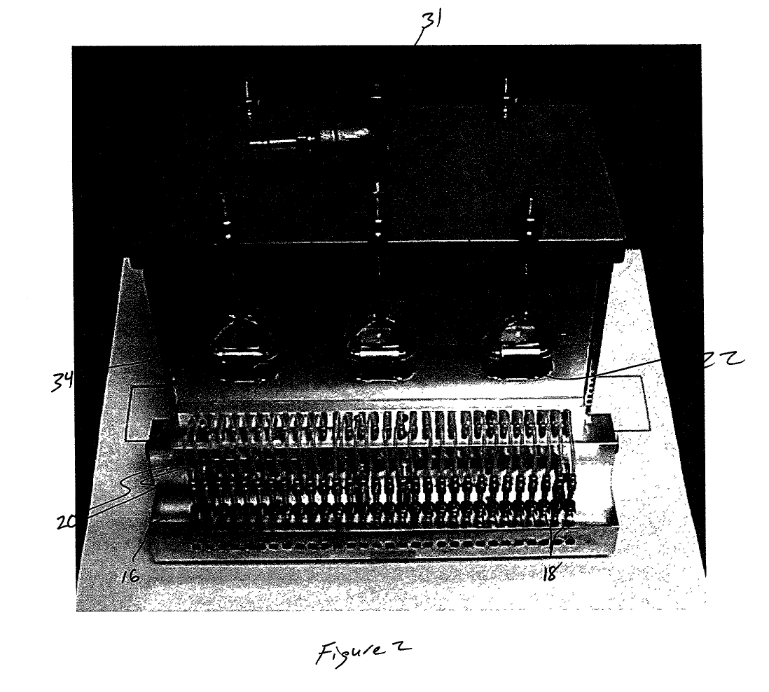

Turning to FIGS. 1 and 2, there is illustrated an exemplary embodiment of the apparatus which is particularly suitable for producing a material of the present invention. The exemplary apparatus 10 is shown in FIG. 1 with chemistry source cover (not shown) (see FIG. 2) removed. As illustrated in FIG. 1, the apparatus has a chemistry source or reservoir 12, a manifold plate 16, a plurality of solenoid valves 18 positioned within the manifold plate 16, and some tubing 20 individually connecting the manifold plate 16 to each of the valves 18. In FIGS. 1 and 2, a first part 22 of attachment means 24 is shown secured to the front wall of the apparatus 10. The second part 26 of attachment means 24 is shown In FIG. 2. FIG. 2 also illustrates chemistry source cover 28 positioned above and secured to the chemistry source 12 of the apparatus 10. While not all embodiments will require that the chemistry source or reservoir 12 be enclosed or pressurized, in those embodiments which do require such enclosure and/or pressurization, it is contemplated that any number of attachment means are suitable for securing the cover or lid 28 to the apparatus 10 provided that the necessary seal is generated. One skilled in the art will appreciate that the necessary seal may vary depending on the embodiment used and/or the amount of pressurization required. Furthermore, while not illustrated, the apparatus of the present invention may further include a gasket or gasketing means to provide a better seal between the chemistry source 12 and the lid or cover 28 therefor. While not shown, the chemistry source may be divided such that more than one chemistry may be utilized in one source. FIG. 2 also illustrates an inlet valve 30. Depending on the setup of the apparatus, inlet valve 30 may provide for the inflow of a desired chemistry and/or the inflow from a pressure source. Alternatively, although not illustrated, the apparatus may have a second inlet valve such that there is one inlet valve through which a chemistry may pass and one through which pressure may be supplied. Furthermore, where the apparatus 10 will utilize more than one chemistry, multiple chemistry sources or reservoirs may incorporate a separate inlet valve for each of the chemistries and a separate inlet valve through which pressure may be supplied. FIG. 2 also illustrates a pressure relief or “bleed” valve 31.

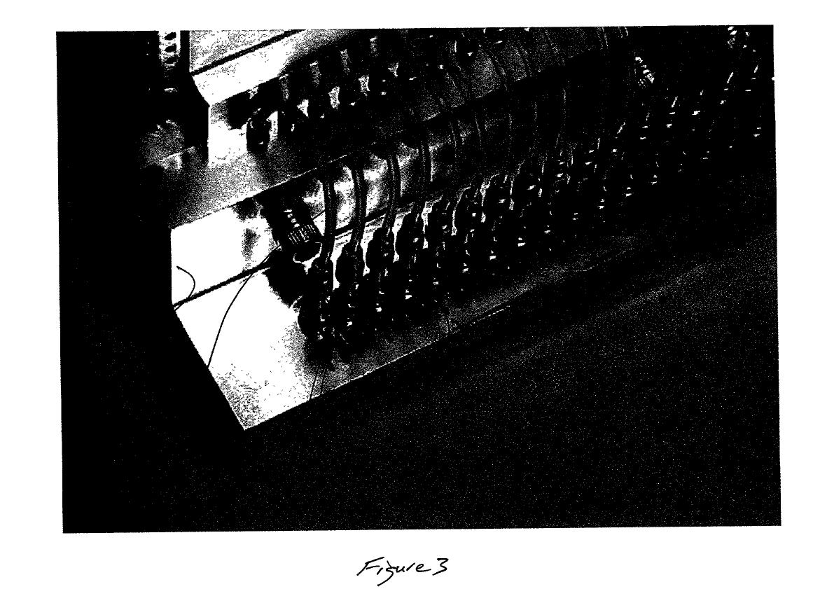

FIG. 3 is an enlarged perspective view of a portion of the device shown in FIGS. 1 and 2. FIG. 3 illustrates the proximity of the valves 18 in the device 10 shown, as well as the connections of the tubing 20 to the valves 18 and the manifold plate 16. FIG. 3 provides sufficient illustration of the valves 18 and the electrical connections 33 which extend from each valve 18 of this device 10. Also shown in the embodiment pictured in FIG. 3 is but one manner of attaching and/or securing the valves 18 to the manifold plate 16. Specifically shown are tightening or retention screws which enable the valves 18 to be held in place along the manifold plate 16. In this embodiment the tightening or retention screws 32 may be readily tightened or loosened by an allen wrench or the like. One skilled in the art will appreciate that any manner or means of securing the valves 18 in place is acceptable, although it is desired that the valves 18 be capable of ready replacement in the event of wear, failure or the like. It is also desirable that the valves 18 be capable of replacement individually.

Each of FIGS. 1-3 illustrates, on at least one surface of the apparatus shown therein, a layer of insulative material 34. While only shown on the larger surfaces of the apparatus 10, the insulative material 34 may be applied to any exterior surface of the apparatus so long as the material 34 will not interfere with the operation of the apparatus. It is contemplated that any suitable insulative material may be used and it is further contemplated that more than one type of insulative material may be desirable in one or more embodiments of the present invention. The insulative material 34 helps maintain the temperature of the at least one chemistries which may be processed by the apparatus of the present invention. The addition of an insulative material has been found to reduce the amount of heat needed to be added, when necessary, to the device during use thereof for proper processing of the at least one chemistries, especially where phase-change materials or chemistries are used.

The apparatus of the present invention may be used to produce a variety of materials having a vast of characteristics, including, for example, but not limited to the materials disclosed in commonly assigned U.S. patent application Ser. No. ______, entitled “MATERIAL HAVING ONE OR MORE CHEMISTRIES WHICH PRODUCE TOPOGRAPHY, UNIQUE FLUID HANDLING PROPERTIES AND/OR BONDING PROPERTIES THEREON AND/OR THEREON” one embodiment of the material of the present invention by emitting or depositing droplets or discrete segments, desirably of about 1-2 mm diameter each, of at least one molten (and desirably a phase-change) liquid (i.e. chemistry). By manipulating the temperature, velocity, and throw distance, for example, the cross-sectional shape of the droplets which solidify on the surface of the substrate may be changed. Thus, for example, if the temperature of the liquid is increased, it will typically penetrate further into the substrate before solidifying, thereby resulting in a more dome-shaped deposit having less height than one formed at a lower temperature. The droplets may be deposited on a wettable substrate at desired X-Y intervals, thus providing, in this example, at least two desirable attributes. The first being that the surface is covered with raised, rounded, hydrophobic domains that force liquid away and into the hydrophilic surrounding field, leaving the domes clean and dry, and the second being that the domes, all being substantially the same height provide a uniform spacing between the wet substrate and the user's skin. The droplets or segments may also be deposited to form discrete domains, consisting of one or more discreted droplets or segments.

While much of the disclosure contained herein is directed to the use of valve jet printing apparatus to produce the materials of the present invention, this embodiment may alternatively be executed by use of a piezo-driven printhead. The piezo-driven print devices are typically capable of emitting droplets having a diameter in the range of about 50-90 micrometers with placement resolution to about 1/200 of an inch. In this instance the micro-droplets may be deposited in a pre-described pattern wherein continuous patterns of ink enclose discrete domains of the wettable substrate. Although, the apparatus of the present invention may operate (e.g. have lengthier dwell times or have multiple rows of valves, etc.) such that the printing may be accomplished in one pass of the apparatus over the substrate or one pass of the substrate by the apparatus, in some instances it may be desirable for the chemistry, and hence the pattern, topography and/or the fluid management characteristics, to be produced or achieved by multiple passes of the substrate past the printhead. The multiple pass approach may be desirable for a number of reasons including, but not limited to, the alteration of each layer from the original in such a way that the cross-sectional shape of a pattern element is desirably developed to, for example, triangular, or hemispherical. Additionally, it may be desirable to produce a material via multiple passes of the substrate past the printhead where releasable treatments or chemistries are used such as those disclosed, for example, in commonly assigned U.S. patent application Ser. No. 09/938,347 to Yahiaoui et al.

In another embodiment the technique of the present invention may be used to print fluid wicking or flow management devices directly onto a chosen substrate with high degrees of accuracy. For example, if it is desired to create a capillary wicking device to transport a certain liquid from a first point on or in the material to a second point on or in the material, while also increasing the width of the wicking field, the idealized material may be digitally realized using a graphics software program. The program may be constrained to use mathmatic requirements particular to the fluid, substrate, and ink such as capillary size, length, pressure, etc, to design the device. Once created, the design may be accurately created on the substrate by inkjet printing.

Yet another embodiment of the material of the present invention involves various forms of bonding. For example, a pattern of droplets emitted from a solenoid valve printhead may be printed on a moving consolidated mat of fibers. The mat can then be compressed and heated to remelt the droplets. The droplets may flow around the fibers, and when solidified stabilize the mat into a bonded web without having damaged the fibers. Alternatively, the pattern of droplets or discrete segments may be applied to one layer of a material before another layer of material (e.g. film, web, etc.) is placed over the first. Upon compression, reheating, and cooling, an interfacial bond may be formed. Because the bond patterns are digitally generated, they are infinitely variable and instantly changeable. The speed at which the patterns may be changed will enable the elimination of a significant amount of costs both in labor to change the applicator rolls previously used, as well as the amount of downtime experienced as a change in bond patterns currently requires the fabrication and installation of a new bond anvil roll at great expense. The implementation of the apparatus of the present invention, including the control means, will reduce the cost of changing applications to essentially zero.

One skilled in the art will appreciate in light of the disclosure herein that in any given product length or length of web the bond pattern may have a range of bond density, or zones of differing bond density. The droplets or discrete segments may be placed so that upon remelting they may become contiguous rendering that zone of the web selectively impermeable. In addition, the droplets may be deposited in a manner that they become a reversible or “unzippable” bond line to be employed by the user to, for example, facilitate fit. For example, a disposable pant may be fabricated having unzippable bond lines that force the pant to conform closely to user being of the intended minimum weight range of the product. The unzippable bond lines may be separated by the user thus bringing the next larger bond lines to force conformation to the next larger weight with the range of the product.

While each product or component of the present invention may require different features or qualities, in at least one product contemplated by the inventors, it would be desirable to include combinations of all the embodiments listed above. For example, a region of hydrophobic spacing droplets may graduate into liquid channeling lines, and further into a micro-wicking region. Liquid channeling lines may simultaneously bond layers, graduate to discrete bond points, with further gradation in bond point density.

In another aspect of the absorbent article of the present invention may have discrete segments having a substantially semicircular cross-section extending above the body-facing surface of the substrate. Further still the discrete segments of the absorbent article will desirably have a volume in the range of about 5 nanoliters to about 400 nanoliters.

While the present invention has been described in connection with certain desired embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

We claim:

1. An apparatus for the discrete and registered placement of chemistry, comprising:
at least one solenoid valve, said valve containing an orifice;
at least one chemistry source, in communication with said at least one valve, and capable of communicating at least one chemistry to at least one solenoid valve; and
a heating element;
wherein the heating element is positioned proximate to at least one chemistry, and wherein the heating element allows the apparatus to process phase-change materials.

2. The apparatus of claim 1 further comprising a control means adapted to operate said at least one solenoid valve;
wherein said control means is in communication with the at least one solenoid valve.

3. The apparatus of claim 1, wherein the at least one chemistry source is selected from a reservoir or a continuous feed system.

4. The apparatus of claim 2, wherein the at least one solenoid valve is controlled so as to discharge the at least one chemistries in a pattern.

5. The apparatus of claim 1 further comprising a manifold plate and wherein the at least one valve is positioned in the manifold plate.

6. The apparatus of claim 5, wherein at least one chemistry is passed through the manifold to at least one solenoid valve.

7. The apparatus of claim 1, wherein the apparatus discharges discrete segments of chemistry.

8. The apparatus of claim 7, wherein the discrete segments have a volume of between about 5 nanoliters and about 400 nanoliters.

9. The apparatus of claim 7, wherein the discrete segments have a length and width less than about 2 mm and greater than about 0.2 mm.

10. The apparatus of claim 7, wherein said discrete segments are discharged at a frequency between about 1 Hz and about 2 kHz.

11. The apparatus of claim 1 further comprising a pressure source, wherein the pressure source maintains adequate pressure in the apparatus so as to assist in the regulation of the chemistry discharge from the at least one orifice.

12. The apparatus of claim 1 further comprising a temperature sensor, wherein the temperature sensor measures the temperature of the at least one chemistry in the apparatus.

13. The apparatus of claim 1, wherein the control means is capable of operation in multiple modes.

14. The apparatus of claim 1, wherein the apparatus can apply the chemistry to a substrate so as to create a topography of chemistry.

15. A printing device for the registered placement of phase-change liquids comprising:
at least one solenoid valve, said valve having a discharge orifice;
a heating element, said element being capable of providing heat to the device so as to allow the utilization of phase-change liquids;
a chemistry supply, said supply being in fluid communication with at least one solenoid valve; and
a control means, adapted to operate with the at least one solenoid valve.

16. The device of claim 15, wherein the chemistry supply is a reservoir or a feed system.

17. The device of claim 15, wherein the valve projects from the orifice droplets of chemistry, containing, at least in part, one or more phase-change liquids.

18. The device of claim 15, wherein the valve projects discrete segments of droplets of chemistry, containing, at least in part, one or more phase-change liquids.

19. A method of placing one or more chemistries in a discrete and registered fashion, said method comprising:
providing a valve jet, said jet comprising: at least one solenoid valve, said valve containing an orifice; at least one chemistry source, said at least one chemistry source in communication with said at least one valve, and said at least one chemistry source is capable of communicating at least one chemistry to at least one solenoid valve; and a heating element; wherein the heating element is positioned proximate to at least one chemistry, and wherein the heating element allows the apparatus to process phase-change materials;
providing an amount of chemistry;
communicating the chemistry from at least one chemistry source to at least one solenoid valve;
providing heat to at least one chemistry; and
discharging at least one chemistry from at least one solenoid valve.

20. The method of claim 19 further comprising:
providing a substrate;
wherein the discharged chemistry forms discrete segments on the substrate.

21. The method of claim 20, wherein the chemistry is applied in one application to a substrate so as to create a topography of chemistry.

22. The method of claim 19, wherein the solenoid valves further comprise a discharge orifice.

23. The method of claim 20, wherein discharging the chemistry from the at least one solenoid valve comprises firing one or more of the at least one valves.

24. The method of claim 19, further comprising:
regulating the discharge of the chemistry from the at least one solenoid valves;
wherein the valve jet further comprises a control element; wherein the control element is in communication with the at least one solenoid valves; and wherein the control element regulates the solenoid valves such that the chemistry is discharged onto the substrate in a pattern.

25. The method of claim 24, wherein the control element provides for real-time adjustment of the discharge from the at least one solenoid valve.

26. The method of claim 20, wherein said discrete segments have a substantially semicircular cross-section extending above the substrate.

27. The method of claim 19, wherein the at least one chemistry is selected from medicaments, inks, waxes, paints, lotions, ointments, skin health agents, topical applications, or combinations thereof.

28. The method of claim 19, wherein at least one chemistry is a phase-change material.

29. The method of claim 20, wherein the substrate is selected from a film, woven, nonwoven, paper and laminates or combinations thereof.

30. The method of claim 20, wherein the discrete segments are applied to the substrate so as to create bond points.

31. The method of claim 30, wherein the discrete segments bond points are inter-fiber bond points or interfacial bond points.

32. The method of claim 19, wherein the viscosity of the at least one chemistry discharged from the valve jet is between about 1 centipoise and about 300 centipoise at the time of discharge.

33. The method of claim 20, wherein the valve jet discharges discrete segments having a volume of between about 5 nanoliters and about 400 nanoliters.
